(19) United States
(12) Patent Application Publication
(10) Pub. No.: US 2011/0012831 A1
(43) Pub. Date: Jan. 20, 2011

(54) INPUT DEVICE AND METHOD FOR INPUTTING CHARACTERS

(76) Inventor: Xun Liu, Beijing (CN)

Correspondence Address: HONEYWELL/SLW;Patent Services, 101 Columbia Road, P.O. Box 2245, Morristown, NJ, 07962-2245, US

(21) Appl. No.: 12/738,708

(22) PCT Filed: Oct. 26, 2007
(86) PCT No.: PCT/CN07/03055

§ 371 Date: Sep. 7, 2010

(30) Foreign Application Priority Data
Dec. 3, 2007 (JP) 2007-312105
Mar. 12, 2008 (JP) 2008-062164

(51) Int. Cl. G06F 3/033

(52) U.S. Cl. 345/161

(57) ABSTRACT

One example embodiment provides an input device for inputting characters. The input device includes a support, a first touch pointer and a second touch pointer supported by the support. The first touch pointer is configured to be pushed in multiple planar directions in a plane and one direction generally perpendicular to the plane to respectively trigger inputting a first set of characters. The second touch pointer is configured to be pushed in multiple planar directions in the plane and one direction generally perpendicular to the plane to respectively trigger inputting a second set of characters.

### TECHNICAL FIELD

The present application relates generally to the technical field of an input device and method for inputting characters.

### BACKGROUND

In daily life, public systems, such as ATM machine, Access Control System (ACS), Point of Sale (POS) machine are widely used. These systems usually need users to input their passwords or Personal Identification Numbers (PIN) by means of conventional input devices. However, during the input process, other people standing aside may easily thieve the passwords or PIN numbers by, for example, “shoulder surfing.”

### BRIEF DESCRIPTION OF THE DRAWINGS

Some embodiments are illustrated by way of examples, and not by way of limitations, in the figures of the accompanying drawings in which:

FIG. 1 is a planar top view illustrating a panel of an input device according to an example embodiment of the present application, in which two touch pointers are used to input characters;

FIG. 2 is a side view of the input device according to the example embodiment of the present application as shown in FIG. 1 along section lines A-A;

FIG. 3 is a cross-section view of one touch pointer of the two touch pointers of the input device according to the example embodiment of the present application as shown in FIG. 1 along section lines C-C;

FIG. 4 is a diagram illustrating a contact structure of the touch pointer according to an example embodiment of the present application as shown in FIG. 3 along section lines B-B;

FIG. 5 is a planar top view illustrating a panel of an input device according to another example embodiment of the present application, in which a touch pointer and a shift key are used to input characters;

FIG. 6 is a perspective view illustrating the use of the input device as shown in FIG. 1 according to an example embodiment of the present application;

FIG. 7 is a perspective view illustrating the use of the input device as shown in FIG. 5 according to another example embodiment of the present application;

FIG. 8 is a perspective view of an input device with a cover according to an example embodiment of the present application;

FIG. 9 is a flowchart illustrating a method of inputting characters according to an example embodiment of the present application; and

FIG. 10 is a flowchart illustrating a method of inputting characters according to another example embodiment of the present application.

### DETAILED DESCRIPTION

In the following description, for purposes of explanation, numerous specific details are set forth in order to provide a thorough understanding of example embodiments. It will be evident, however, to one skilled in the art that the example embodiments of the application may be practiced without these specific details.

The term “touch pointer” in the following description denotes an input element that can sense the push or press in a plurality of different directions. The “touch pointer” is similar to a multi-way navigation key or a multi-way switcher on, for example, some mobile phones or MP3 players.

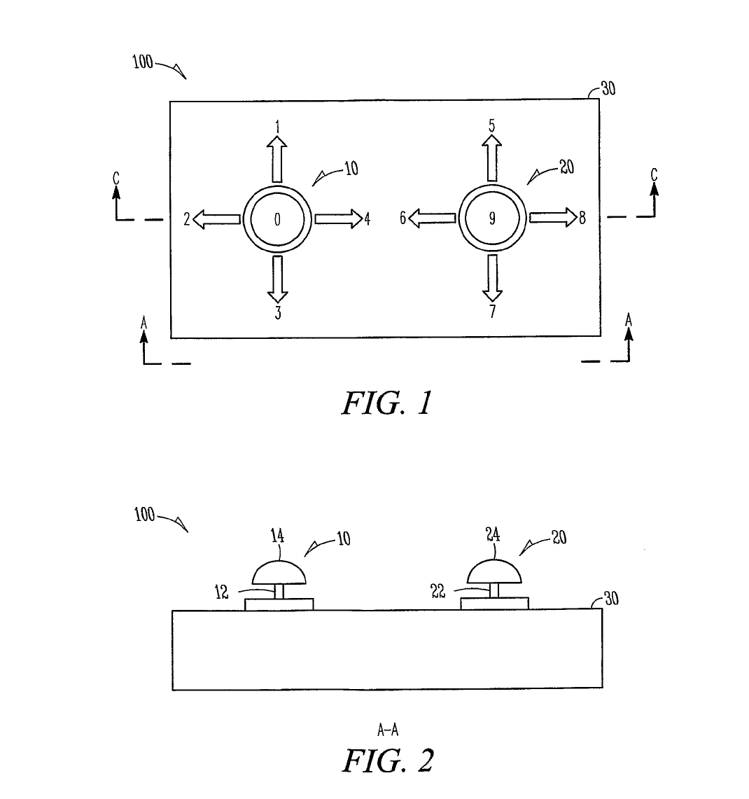

FIG. 1 is a planar top view illustrating a panel of an input device according to an example embodiment of the present application, in which two touch pointers are used to input characters. In the example embodiment, the input device 100 includes a support or body 30, and a pair of touch pointers 10 and 20 supported by the support 30. Each of touch pointers 10 and 20 can be pushed or pressed in five different directions, e.g., left, right, forward, backward, and down to respectively trigger inputting different characters. When the touch pointer 10 is pushed forward, numeric “1” is input; when the touch pointer 10 is pushed left, numeric “2” is input; when the touch pointer 10 is pushed backward, numeric “3” is input; when the touch pointer 10 is pushed right, numeric “4” is input; when the touch pointer 10 is pressed down, numeric “0” is input. Similarly, when the touch pointer 20 is pushed forward, numeric “5” is input; when the touch pointer 20 is pushed left, numeric “6” is input; when the touch pointer 20 is pushed backward, numeric “7” is input; when the touch pointer 20 is pushed right, numeric “8” is input; when the touch pointer 20 is pushed down, numeric “9” is input.

While FIG. 1 shows that the input device 100 is used to input numeric characters “0”, “1”, “2”, “3”, “4”, “5”, “6”, “7”, “8” and “9”, it is understood by those skilled in the art that the input device 100 can also be used to input any type of characters, such as alphabetic characters. FIG. 1 shows that two touch pointers 10 and 20 are used in the input device 100 to input characters. In further example embodiment, the number of the touch pointers used in the input device 100 is not limited to two. In an example embodiment, the input device 100 can use only one touch pointer to input characters. In another example embodiment, the input device 100 can use more than two touch pointers, e.g., three or even more touch pointers to input characters.

FIG. 2 is a side view of the input device according to the example embodiment of the present application as shown in FIG. 1 along section lines A-A. As shown in FIG. 2, the touch pointers 10 and 20 of the input device 100 are supported by the support 20, and respectively include hats 14 and 24 and poles 12 and 22 connected thereto.

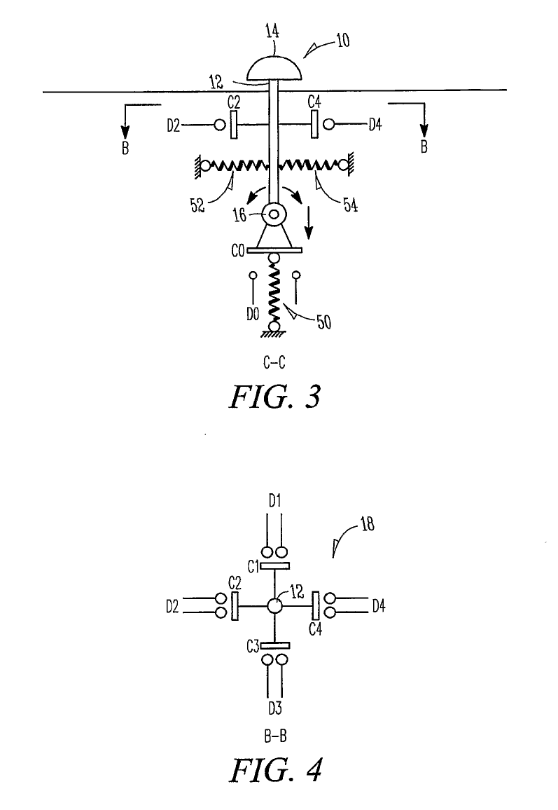

FIG. 3 is a cross-section view of the touch pointer 10 of the input device 100 according to the example embodiment of the present application as shown in FIG. 1 along section lines C-C, which shows the internal structure of the touch pointer 10. In the example embodiment, the structure of the touch pointer 20 is the same as the structure of touch pointer 10.

As shown in FIG. 3, in the example embodiment, the touch pointer 10 includes a hat 14, a hinge 16, and a pole 12, which connects the hat 14 and the hinge 16 at the two ends thereof. The hat 14 is designed to have a size suitable for a finger or thumb to easily push or press the pole 12. The pole 12 may include five contacts C0, C1, C2, C3 and C4 fixed thereto (C1 and C3 are not shown in FIG. 3, but are shown in FIG. 4) as parts of a contact structure 18, which is shown in more detail in FIG. 4.

Still referring to FIG. 3, the example pole 12 may include an elastic structure to resume the pole 12 to neutral position, after a push to it is released. In some example embodiments, the elastic structure includes a plurality of dampers or springs coils, e.g., S0, S1, S2, S3, S4 (S1 and S3 are not shown in FIG. 3). While FIG. 3 only illustrates a plurality of dampers used as such a pole position resuming structure, it is understood that other conventional structures can also be used to resume the pole 12 to neutral position, after a push to the pole 12 is released.

While the pole position resuming structure as shown in FIG. 3 uses for example dampers and hinges, it should be understood that the pole position resuming structure can take other forms. In one example embodiment, the pole position resuming structure can be of the same structure as the “red hat” of IBM Notebook, which actually has not hinge and dampers.

In some example embodiments, a multi-way switcher or a multi-way navigation key (e.g., typically used with remote control of television or MP3) can be used as the touch pointer.

FIG. 4 is a diagram illustrating a contact structure 18 of the touch pointer 10 according to an example embodiment of the present application as shown in FIG. 3 along section lines B-B. The contact structure 18 may include, for example, five switch points D0 (D is not shown in FIG. 4, but is shown in FIG. 3), D1, D2, D3 and D4 inside the panel of the input device 100, respectively corresponding to the five contacts C0, C1, C2, C3 and C4 of the pole 12. In one example embodiment, D0, D1, D2, D3, D4 are the switch points of keypad interface circuit. The keypad interface circuit and the process program can be arranged in such a way that, when D0, D1, D2, D3, D4 is switch on, the circuit and process program would trigger the corresponding “0”, “1”, “2”, “3”, and “4” input.

Referring to FIG. 4, in the example embodiment, when the hat 14 being pushed in any one of the directions selected from forward, left, backward and right, the pole 12 may rotate around the hinge 16 and thus may make one of the contacts C1, C2, C3 and C4 get into contact with the corresponding switch point selected from D1, D2, D3 and D4. Referring again to FIG. 3, when the hat 14 being pressed down, the pole 12 may make the contact C0 get into contact with the switch point D0. In this way, any numeric selected from “0”, “1”, “2”, “3” and “4” can be input by pushing or pressing the hat 14 in a corresponding direction. Since the structure of the touch pointer 20 is the same as the structure of touch pointer 10, any numeric selected from “9”, “5”, “6”, “7” and “8” can be input by pushing or pressing the hat 24 of the touch pointer 20 in a corresponding direction as described above.

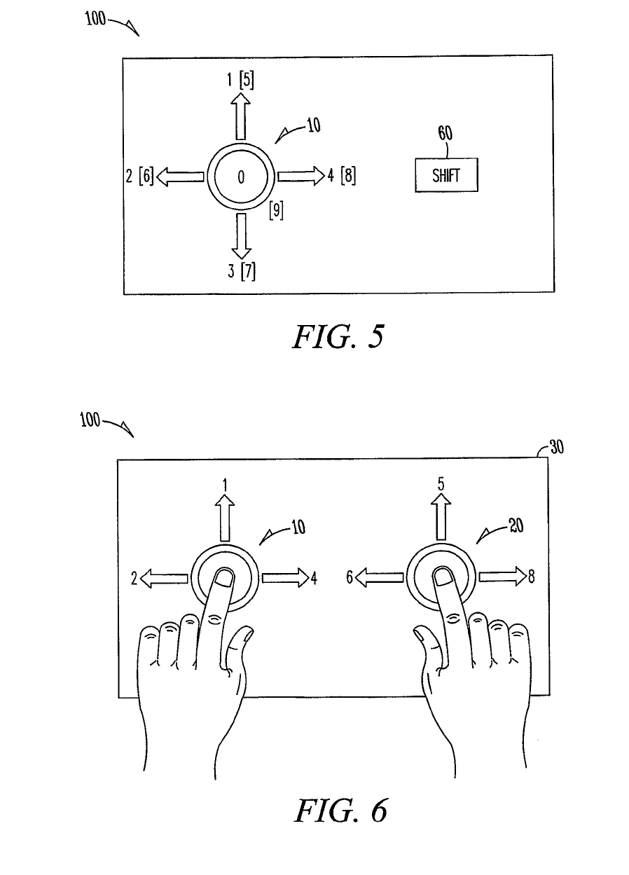

FIG. 5 is a planar top view illustrating an input device 100 according to another example embodiment of the present application. In this example embodiment, the input device 100 includes a touch pointer 10, and a shift key 60 to be used in combination with the touch pointer 10 to input characters. As shown in FIG. 5, when the shift key 60 is released, pressing down the touch pointer 10 and pushing the touch pointer 10 to four directions, such as forward, left, backward, and right, can respectively input numeric “0”, “1”, “2”, “3” and “4”. On the other hand, when the shift key 60 is pressed, pressing down the touch pointer 10 and pushing the touch pointer 10 to four directions, such as forward, left, backward, and right, can respectively input numeric “9”, “5”, “6”, “7” and “8”. Then, any passwords or PIN numbers may be input by the use of only one touch pointer 10 in combination with the shift key 60.

In one example embodiment, a graphic image similar in appearance to the planar top view of the input device 100 shown in FIG. 5 may be provided on a display separate from the input device 100. This image may assist a user in entering characters without needing to view the actual input device 100. The display may be an electronic type display or simply printed symbols on a convenient surface.

In some embodiments, the shift function can be easily implemented by updating an interface software of the input device 100. There may be a Boolean type variable to record the pressed down status of the shift key 60. For example, if the shift key 60 is released, the variable can be set to be false. If the shift key 60 is pressed down, the variable can be set to be true. When the touch pointer 10 is pushed to a direction, the program of the interface software can decide the final input signal according to the status (pressed down or not) of the shift key 60.

While FIG. 5 shows that the touch pointer 100 includes only one shift key 60 in combination with the touch pointer 10 to input characters, it is understood by those skilled in the art that the number of the shift key 60 used in the input device 100 is not limited to one. For example, the input device 100 can use five shift keys 60 in combination with one touch pointer 10, and thus can be used to input the 26 English letters in the alphabet.

FIG. 6 shows an example of the use of the input device 100 as shown in FIG. 1 according to an example embodiment of the present application. In this example embodiment, a user may use two hands to respectively operate the touch pointers 10 and 20 in order to input characters selected from “0”, “1”, “2”, “3”, “4”, “5”, “6”, “7”, “8” and “9”. While FIG. 6 illustrates that the user uses index fingers to push the touch pointers 10 and 20, it is understood that the user may use any fingers, for example thumbs, to input characters.

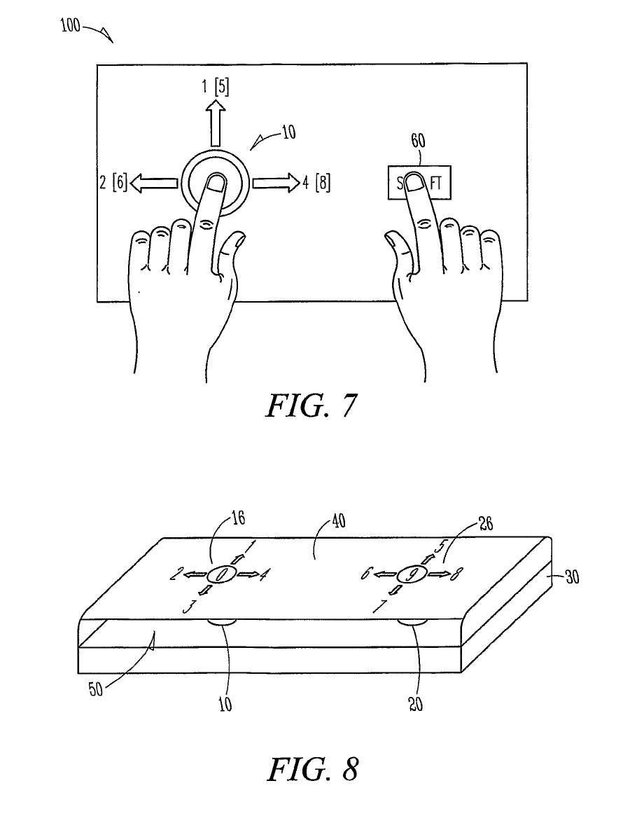

FIG. 7 shows an example of the use of the input device 100 as shown in FIG. 5 according to another example embodiment of the present application. In this example embodiment, a user may use one hand to push the touch pointer 10, and another hand to control the shift key 60 to input characters. When the shift key 60 released, the user may input any numeric characters selected from “0”, “1”, “2”, “3” and “4” by pressing down the touch pointer 10 or pushing the touch pointer 10 to one of the forward, left, backward, and right directions. On the other hand, when the shift key 60 pressed, the user may input any numeric characters selected from “9”, “5”, “6”, “7” and “8” by pressing down the touch pointer 10 or pushing the touch pointer 10 to one of the forward, left, backward, and right directions.

FIG. 8 is a perspective view of an input device 100 with a cover 40 according to an example embodiment of the present application. In the example embodiment, the input device 100 may include a translucent or opaque cover 40 over the touch pointers 10 and 20 in order to block the sight of the people standing aside. The cover 40 has an opening 50 in the front side with a size suitable to allow a user to operate the touch pointers 10 and 20. The cover 40 may have markings or indications 16 and 26 on the outside surface in order to remind the user of the relationship between the directions to push the touch pointers and the corresponding characters to be input.

In this way, the cover 40 may block the sight of the people standing aside to further prevent from shoulder surfing, and does not affect the operation of the touch pointers by a user. With the aid of the indications 16 and 26 on the cover 40, an inexperienced user may also easily input characters, like PIN numbers, by just pushing a corresponding touch pointer each time in a direction as indicated, without even looking at the touch pointers 10 and 20.

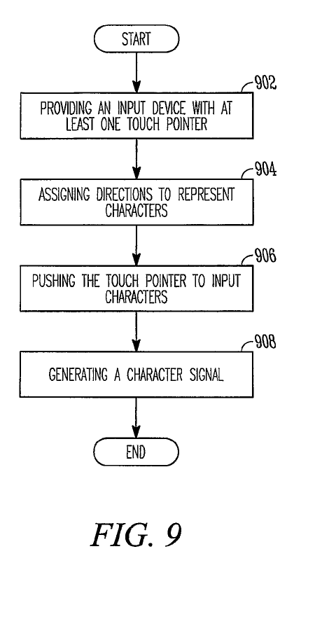

FIG. 9 is a flowchart illustrating a method of inputting characters according to an example embodiment of the present application.

At 902, an input device is provided with at least one touch pointer. For example, the input device 100 as shown in FIG. 1 can be used in this example embodiment, which has two touch pointers 10 and 20.

At 904, multiple planar directions in a plane and a direction generally perpendicular to the plane to push the touch pointer are assigned to represent a set of characters. As shown in FIG. 1, each of touch pointers 10 and 20 can be pushed or pressed in five different directions, e.g., left, right, forward, backward, and down, to respectively trigger inputting different characters. It should be understood that the push down direction of the touch pointer does not need to be strictly perpendicular to the left, right, forward, and backward directions.

At 906, the touch pointers 10 and 20 are pushed sequentially in at least one direction selected from the multiple planar directions in the plane and the direction perpendicular to the plane, to trigger inputting at least one character selected from the set of characters. As shown in FIG. 1, for example, when the touch pointer 10 is pushed forward, numeric “1” is input; when the touch pointer 10 is pushed left, numeric “2” is input; when the touch pointer 10 is pushed backward, numeric “3” is input; when the touch pointer 10 is pushed right, numeric “4” is input; when the touch pointer 10 is pushed down, numeric “0” is input. Similarly, when the touch pointer 20 is pushed forward, numeric “5” is input; when the touch pointer 20 is pushed left, numeric “6” is input; when the touch pointer 20 is pushed backward, numeric “7” is input; when the touch pointer 20 is pushed right, numeric “8” is input; and when the touch pointer 20 is pushed down, numeric “9” is input.

At 908, a character signal corresponding to the input characters is generated. For example, by means of the input device 100 shown in FIG. 1, in order to input a character signal or password “1981960”, a user may push the touch pointers 10 and 20 in the following sequence: push the touch pointer 10 forward for numeric “1”, press the touch pointer 20 down for numeric “9”, push the touch pointer 20 right for numeric “8”, push the touch pointer 10 forward for numeric “1”, press the touch pointer 20 down for numeric “9”, push the touch pointer 20 left for numeric “6”, and press the touch pointer 10 down for numeric “0”. As a result, the character signal corresponding the password “1981960” is generated.

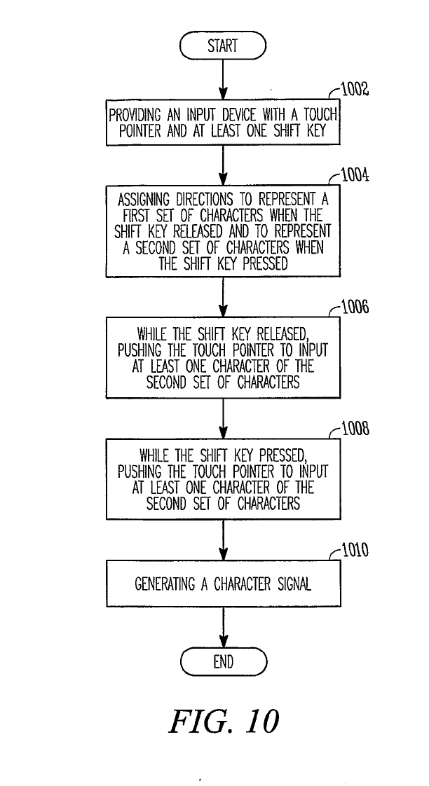

FIG. 10 is a flowchart illustrating a method of inputting characters according to another example embodiment of the present application.

At 1002, an input device is provided with a touch pointer and at least one shift key. For example, the input device 100 as shown in FIG. 5 can be used, which includes a touch pointer 10 and a shift key 60.

At 1004, multiple planar directions in a plane and a direction generally perpendicular to the plane to push the touch pointer 10 are assigned, to represent a first set of characters when the shift key 60 is released, and to represent a second set of characters when the shift key is pressed. Referring again to FIG. 5, the first set of characters consists of numeric characters “0”, “1”, “2”, “3” and “4”, and the second set of characters consists of numeric characters “9”, “5”, “6”, “7” and “8”. When the shift key 60 is released, the directions to press down and to push the touch pointer 10 forward, left, backward, and right respectively represent numeric characters “0”, “1”, “2”, “3” and “4”. On the other hand, when the shift key 60 is pressed, the directions to press down and to push the touch pointer 10 forward, left, backward, and right respectively represent numeric characters “9”, “5”, “6”, “7” and “8”. It should be understood that the push down direction of the touch pointer 10 does not need to be strictly perpendicular to the left, right, forward, and backward directions.

At 1006, while the shift key 60 released, the touch pointer 10 is pushed sequentially in at least one direction selected from the multiple planar directions in the plane and the direction generally perpendicular to the plane, to trigger inputting at least one character selected from the first set of characters. Referring again to FIG. 5, when the shift key 60 is released, pressing down the touch pointer 10 and pushing the touch pointer 10 to four directions, such as forward, left, backward, and right, can respectively trigger inputting numeric characters “0”, “1”, “2”, “3” and “4”.

At 1008, while the shift key 60 is pressed, the touch pointer 10 is pushed sequentially in at least one direction selected from the multiple planar directions in the plane and the direction generally perpendicular to the plane, to trigger inputting at least one character selected from the second set of characters. Referring again to FIG. 5, when the shift key 60 is pressed, pressing down the touch pointer 10 and pushing the touch pointer 10 to four directions, such as forward, left, backward, and right, can respectively trigger inputting numeric characters “9”, “5”, “6”, “7” and “8”.

At 1010, a character signal corresponding to the at least one input character is generated. In this way, any passwords or PIN numbers may be input by the use of only one touch pointer 10 in combination with the shift key 60.

With the input device 100 as shown in the example embodiments of the present application, users only need to use fingers to slightly push or press touch pointers in order to input characters, like numbers and/or letters in the alphabet. Chances for character information password or PIN number to be thieved can therefore be largely reduced. By the aid of the input device, users can even input, e.g., passwords or PIN numbers, only by sense of touch, which makes it possible to eliminate “shoulder surfing”.

While there has been described herein the principles of the application, it is to be understood by those skilled in the art that this description is made only by way of example and not as a limitation to the scope of the application. Accordingly, it is intended by the appended claims, to cover all modifications of the application which fall within the true spirit and scope of the application.

1. An input device, comprising:
a support, including a first set of switch points respectively corresponding to a first set of numbers 1, 2, 3, 4 and 0, and a second set of switch points respectively corresponding to a second set of numbers 5, 6, 7, 8 and 9;
a first touch pointer supported by the support and having a first pole, the first touch pointer is configured to be pushed in forth, left, back, right, and down directions to respectively trigger inputting the first set of numbers; and
a second touch pointer supported by the support and having a second pole, the second touch pointer is configured to be pushed in forth, left, back, right, and down directions to respectively trigger inputting the second set of numbers,
wherein each pole of the first and second poles includes five contacts to get into contact with corresponding switch points, the corresponding switch points are configured to trigger inputting corresponding numbers.

2. The input device of claim 1, wherein the each pole includes a hinge around which the each pole rotates, and an elastic device to resume the each pole to neutral position after a push is released.

3. The input device of claim 2, wherein the elastic device includes a plurality of dampers.

4. An input device, comprising:
a support;
a first touch pointer supported by the support, configured to be pushed in multiple planar directions in a plane and one direction generally perpendicular to the plane to respectively trigger inputting a first set of characters; and
a second touch pointer supported by the support, configured to be pushed in multiple planar directions in the plane and one direction generally perpendicular to the plane to respectively trigger inputting a second set of characters.

5. The input device of claim 4, wherein the first set of characters consists of numeric 1, 2, 3, 4 and 0, and the second set of characters consists of numeric 5, 6, 7, 8 and 9.

6. The input device of claim 4, wherein the support comprises a first set of switch points for the first touch pointer and a second set of switch points for the second touch pointer, the first set of switch points are associated with the first set of characters, and a second set of switch points are associated with the second set of characters.

7. The input device of claim 6, wherein each touch pointer of the first and second touch pointers comprises a hat and a pole connected thereto, the pole includes contacts to get into contact with the corresponding switch points when the hat is pushed.

8. The input device of claim 7, wherein the pole includes a hinge around which the pole turns.

9. The input device of claim 7, wherein the pole includes an elastic device to resume the pole to neutral position after a push to the pole is released.

10. The input device of claim 9, wherein the elastic device includes a plurality of dampers.

11. The input device of claim 4, further comprising a translucent or opaque cover the first and second touch pointers to prevent from shoulder surfing.

12. The input device of claim 11, wherein a surface of the cover includes indication to show relationship of the directions to push and the characters to input.

13. An input device, comprising:
a support;
a touch pointer supported by the support, configured to be pushed in multiple planar directions in a plane and one direction generally perpendicular to the plane to respectively trigger inputting a set of characters.

14. The input device of claim 13, wherein the set of characters consists of numeric 1, 2, 3, 4 and 5.

15. An input device, comprising:
a support;
at least one shift key supported by the support;
a touch pointer supported by the support, configured to be pushed in at least one direction selected from multiple planar directions in a plane and one direction generally perpendicular to the plane, to respectively trigger inputting a first set of characters when the shift being released, and to respectively trigger inputting a second set of characters when the shift being pressed.

16. The input device of claim 15, wherein the first set of characters consists of numeric 1, 2, 3, 4, and 0, and the second set of characters consists of numeric 5, 6, 7, 8, and 9.

17. The input device of claim 15, wherein each character of the first and second set of characters is an alphabetic letter or a numeric.

18. A method of inputting characters, comprising:
providing an input device with at least one touch pointer;
assigning multiple planar directions in a plane and a direction generally perpendicular to the plane to push the touch pointer to represent a set of characters;
pushing sequentially the touch pointer in at least one direction selected from the multiple planar directions in the plane and the direction generally perpendicular to the plane, to trigger inputting at least one character selected from the set of characters; and
generating a character signal corresponding to the at least one input character.

19. A method of inputting characters, comprising:
providing an input device with a touch pointer and at least one shift key;
assigning multiple planar directions in a plane and a direction generally perpendicular to the plane to push the touch pointer, to represent a first set of characters when the shift key is released, and to represent a second set of characters when the shift key is pressed;
while the shift key released, pushing sequentially the touch pointer in at least one direction selected from the multiple planar directions in the plane and the direction generally perpendicular to the plane, to trigger inputting at least one character selected from the first set of characters;
while the shift key pressed, pushing sequentially the touch pointer in at least one direction selected from the multiple planar directions in the plane and the direction generally perpendicular to the plane, to trigger inputting at least one character selected from the second set of characters; and
generating a character signal corresponding to the at least one input character.

20. The method of claim 19, wherein the first set of characters consists of numbers 1, 2, 3, 4, and 0, and the second set of characters consists of numbers 5, 6, 7, 8, and 9.
